(19) United States
(12) Patent Application Publication
(10) Pub. No.: US 2010/0166235 A1
(43) Pub. Date: Jul. 1, 2010

(54) SILICON CONDENSER MICROPHONE

(75) Inventor: RUI ZHANG, Shenzhen (CN)

Correspondence Address: Jamie Zheng, 3524 Waverley Street, Palo Alto, CA, 94306, US

(73) Assignees: AAC ACOUSTIC TECHNOLOGIES (SHENZHEN) CO., LTD, Shenzhen (CN); AMERICAN AUDIO COMPONENTS INC., La Verne, CA (US)

(21) Appl. No.: 12/567,764

(22) Filed: Sep. 26, 2009

(30) Foreign Application Priority Data
Dec. 26, 2008 (CN) 200810241837.X

(51) Int. Cl. H04R 11/04

(52) U.S. Cl. 381/174

(57) ABSTRACT

A silicon condenser microphone includes a silicon substrate defining an opening, a diaphragm supported above the substrate, a backplate opposite to the diaphragm for forming a capacitor together with the diaphragm. The diaphragm includes a central vibrating portion and a plurality of arms extending from an edge of the vibrating portion. Each of the arms includes a first end connecting to the edge of the vibrating portion and a linking portion extending along a path having the same outline as that of the vibrating portion.

### 1. FIELD OF THE INVENTION

The present invention relates to MEMS (micro-electro-mechanical system) components, and more particularly, to a MEMS microphone having a diaphragm.

### 2. BACKGROUND OF THE INVENTION

Silicon based capacitive transducers, such as MEMS microphones, are well known in the art. Silicon condenser microphones are widely used in mobile phones to receive and convert sound waves into electrical signals. Typically, such a microphone generally comprises a silicon substrate, a backplate arranged on the substrate, and a moveable diaphragm separated from the backplate for forming a capacitor.

When the diaphragm is actuated to vibrate by voice waves, a distance from the diaphragm to the backplate is changed, and as a result, the capacitance value of the capacitor is accordingly changed, by which voice waves are converted into electrical signals. However, the voice waves on the diaphragm directly affect the sensitivity of the microphone, and in a conventional microphone, deflection of the diaphragm results in negative effect on the sensitivity and performance of the microphone.

### SUMMARY OF THE INVENTION

Accordingly, embodiments of the present invention are made to resolve the problem mentioned above. According to an aspect of the present invention, a silicon condenser microphone includes a silicon substrate defining an opening, a diaphragm supported above the substrate, a backplate opposite to the diaphragm for forming a capacitor together with the diaphragm. The diaphragm includes a central vibrating portion and a plurality of arms extending from an edge of the vibrating portion. Each of the arm includes a first end connecting to the edge of the vibrating portion and a linking portion extending along a path having the same outline as that of the vibrating portion.

Other features and advantages of the present invention will become more apparent to those skilled in the art upon examination of the following drawings and detailed description of preferred embodiments.

### BRIEF DESCRIPTION OF THE DRAWINGS

FIG. 1 is an isometric view of a microphone in accordance with a first embodiment of the present invention;

FIG. 2 is a cut-away view of the microphone in FIG. 1;

FIG. 3 is a cross-sectional view of the microphone in FIG. 2;

FIG. 4 is a top view of the microphone in FIG. 1;

FIG. 5 is an isometric view of the microphone in FIG. 2, from which a diaphragm of the microphone is removed;

FIG. 6 is a top view of a microphone in accordance with a second embodiment of the present invention; and

FIG. 7 is a top view of a microphone in accordance with a third embodiment of the present invention.

### DETAILED DESCRIPTION OF EMBODIMENTS OF THE INVENTION

Reference will now be made to describe the embodiments of the present invention in detail.

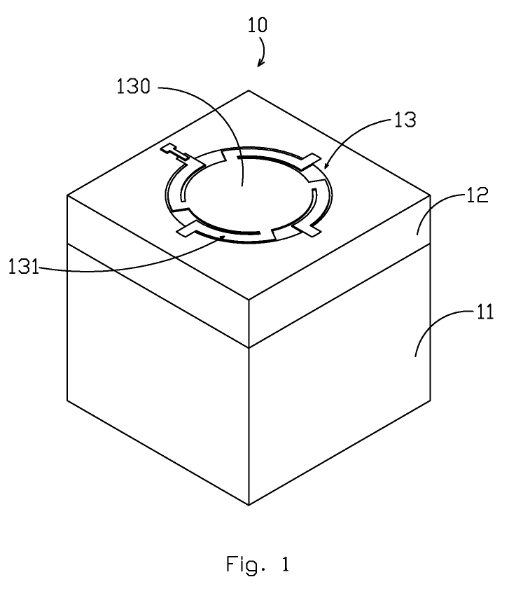

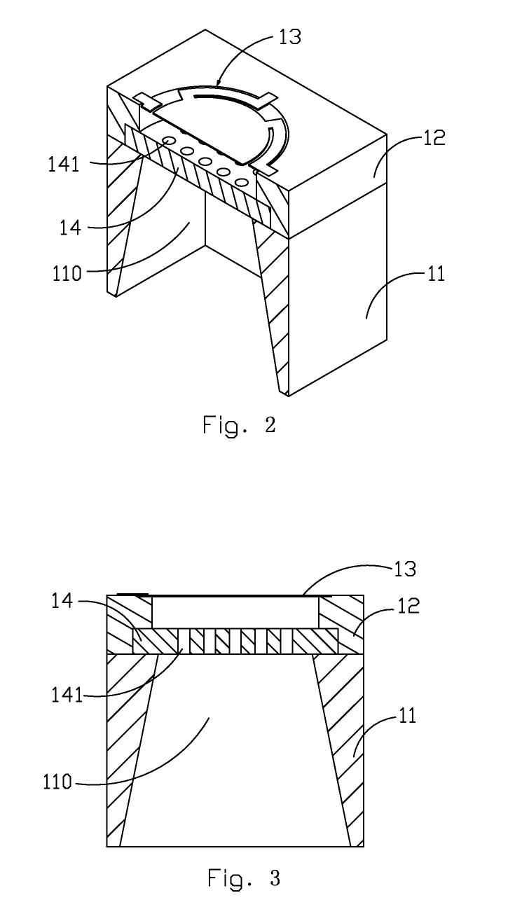

Referring to FIGS. 1-3, a silicon condenser microphone 10, in accordance with a first embodiment of the present invention, comprises a silicon substrate 11 defining an opening 110 therein, a support 12 disposed above the substrate 11, a diaphragm 13 supported by the support 12, and a backplate 14 opposite from the diaphragm 13. The backplate 14 includes a plurality of holes 141 in a central portion thereof and forms a capacitor together with the diaphragm 13. When the diaphragm 12 is actuated to vibrate by sound pressure of external acoustic waves, a distance from the diaphragm 13 to the backplate 14 is changed, which leads into variable capacitance values and variable electrical signals. The diaphragm 13 includes a circular vibrating portion 130 and a plurality of arms 131 extending from an edge of the vibrating portion 130.

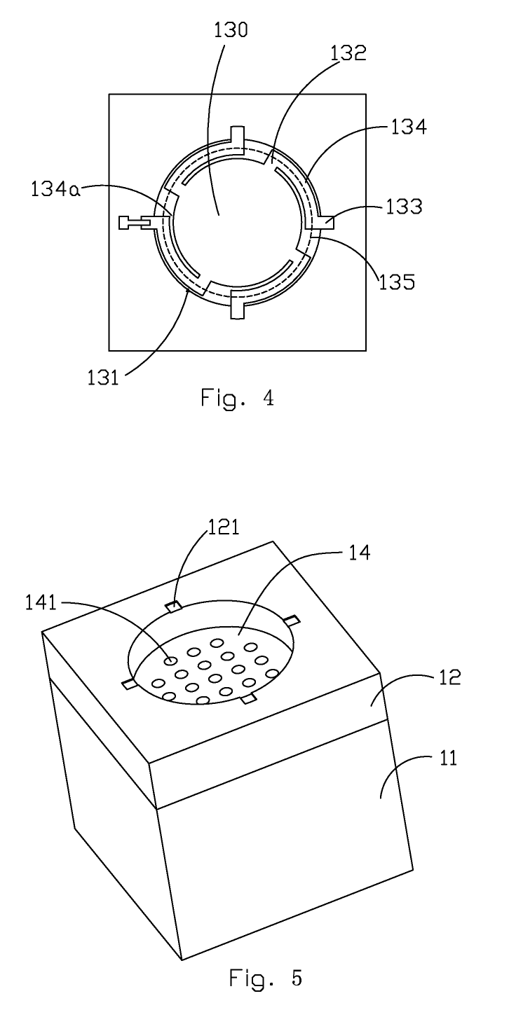

Referring to FIGS. 4-5, each of the arms 131 includes a connecting portion 132 extending from the edge of the vibrating portion 130, a distal end 133 anchored to the support 12, and a linking portion 134 extending between the connecting portion 132 and the distal end 133. The linking portions 134 are configured to be parts of a circle 135. The circle 135 has a common center with the vibrating portion 130. In this exemplary embodiment, four linking portions 134 are provided to form the circle 135. Four arms 131 are shown only as one example, and the present invention is not limited or restricted to a microphone having four arms. A gap 134a is formed between the linking portion 134 and the edge of the vibrating portion 130, and the gap 134a has an even width between the linking portion 134 and the edge along the circle 135. The support 12 defines a plurality of grooves 121 for receiving and positioning the distal ends 133 of the arms 131. The arms 131 and the grooves 121 are symmetrical about the center of the diaphragm 13. The vibrating portion 130 is thus suspended by the arms 131 and can vibrate along a direction perpendicular to the substrate 11. Accordingly, the arm 131 is obviously lengthened, which can effectively improve the sensitivity of the microphone.

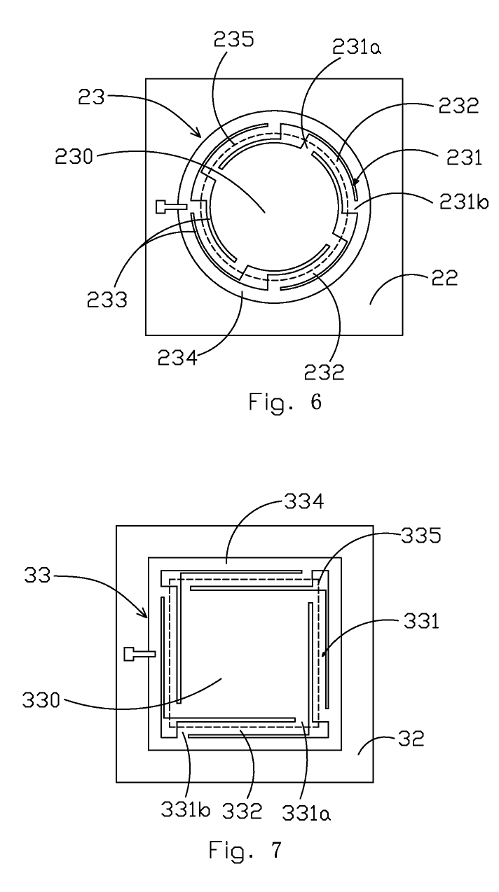

FIG. 6 illustrates a microphone in accordance with a second embodiment of the present invention. The microphone includes a diaphragm 23, and a substrate 22 supporting the diaphragm 23. The diaphragm 23 comprises a circular vibrating central body 230, a periphery 234, and a plurality of arms 231. Each of the arms 231 extends between the central body 230 and the periphery 234, with a first end 231a connecting to the central body 230, and a second end 231b connecting to the periphery 234. A linking portion 232 is provided to connect the first and second ends. Linking portions 232 are configured to be parts of a circle 235 having a common center with the central body 230. Gaps 233 are respectively formed between the linking portion 232 and the central body 230, and between the linking portion and the periphery 234. The gap 233 has an even width between the linking portion 232 and periphery 234 along the circle 235. The periphery 234 is anchored to the substrate 22 and the diaphragm 23 is accordingly suspended by the arms 231. The arm 231 is obviously lengthened, which can effectively improve the sensitivity of the microphone.

With reference to FIG. 7, a third embodiment of the present invention is similar to the second embodiment. The diaphragm 33 in this embodiment includes a rectangular vibrating central 330, a periphery 334, and a plurality of arms 331. Each of the arms 331 includes a first end 331a connecting to the central body 330, a second end 331b connecting to the periphery 334, and a straight linking portion 332 connecting the first and second ends. Linking portions 332 are configured to be parts of a rectangle 335.

In brief, disclosures of the present invention provide silicon condenser microphones including diaphragms defining central vibrating portions and linking portions extending from the vibrating portions along a path having the same outlines as that of the vibrating portions.

While the present invention has been described with reference to a specific embodiment, the description of the invention is illustrative and is not to be construed as limiting the invention. Several of modifications to the present invention can be made to the preferred embodiment by those skilled in the art without departing from the true spirit and scope of the invention as defined by the appended claims.

What is claimed is:

1. A silicon condenser microphone comprising:
a silicon substrate defining an opening;
a diaphragm supported above the substrate;
a backplate opposite from the diaphragm for forming a capacitor together with the diaphragm; and wherein
the diaphragm includes a central vibrating portion and a plurality of arms extending from an edge of the vibrating portion, each of the arm including a first end connecting to the edge of the vibrating portion and a linking portion extending along a path having the same outline as that of the vibrating portion.

2. The silicon condenser microphone as described in claim 1, wherein each of the arms has a second end anchored to the substrate.

3. The silicon condenser microphone as described in claim 1, wherein the diaphragm further has a periphery anchored to the substrate, and the linking portion is connected to the periphery by a second end.

4. The silicon condenser microphone as described in claim 1, wherein the vibrating portion is circular and the path is a circular having the same center with the vibrating portion.

5. The silicon condenser microphone as described in claim 1, wherein the vibrating portion is rectangular and each of the linking portions is parallel to the edge, from which the linking portion extends.

6. The silicon condenser microphone as described in claim 2 further comprising a support arranged on the substrate for supporting the diaphragm.

7. The silicon condenser microphone as described in claim 6, wherein the support defines a plurality of grooves for receiving and positioning the second ends of the arms of the diaphragm.

8. A silicon condenser microphone comprising:
a substrate having an opening;
a diaphragm, located above the substrate, including a central vibrating portion and a plurality of arms extending from an edge of the vibrating portion, each of the arms including a first end connecting to the edge and a linking portion extending from the first end along a path;
a backplate opposite from the diaphragm and having a plurality of through holes; and wherein
a gap is formed between the linking portion and the edge, and the gap has an even width between the linking portion and the edge along the path.

9. The silicon condenser microphone as described in claim 8, wherein each of the arms has a second end anchored to the substrate.

10. The silicon condenser microphone as described in claim 8, wherein the diaphragm further has a periphery anchored to the substrate, and the linking portion is connected to the periphery by a second end.

11. The silicon condenser microphone as described in claim 8, wherein the vibrating portion is circular and the path is a circular having the same center with the vibrating portion.

12. The silicon condenser microphone as described in claim 8, wherein the vibrating portion is rectangular and each of the linking portions is parallel to the edge, from which the linking portion extends.

13. The silicon condenser microphone as described in claim 9 further comprising a support arranged on the substrate for supporting the diaphragm.

14. The silicon condenser microphone as described in claim 13, wherein the support defines a plurality of grooves for receiving and positioning the second ends of the arms of the diaphragm.
